(19) United States
(12) Patent Application Publication
(10) Pub. No.: US 2012/0295109 A1
(43) Pub. Date: Nov. 22, 2012

(54) LINEAR FIBRE FORMATION COMPRISING NANOFIBRES AND METHOD AND DEVICE FOR ITS PRODUCTION

(76) Inventors: Oldrich Jirsak, Liberec (CZ); Filip Sanetrnik, Liberec (CZ); Ladislav Mares, Liberec (CZ)

(21) Appl. No.: 13/511,442

(22) PCT Filed: Nov. 24, 2010
(86) PCT No.: PCT/CZ2010/000118

§ 371 Date: Jul. 31, 2012

(30) Foreign Application Priority Data
Nov. 27, 2009 (CZ) PV 2009-797

(51) Int. Cl. B05D 1/04; B05B 5/025; D02G 3/38; D02G 3/36; B82Y 40/00; B82Y 30/00

(52) U.S. Cl. 428/377; 427/458; 118/621; 977/778; 977/890

(57) ABSTRACT

The invention relates to a linear fibre formation comprising nanofibres deposited on a linear fibre core, at the same time the nanofibres are to the core fixed with a coil of at least one covering thread. The invention further relates to a method and a device for production of a linear fibre formation comprising a linear fibre core, on which in a spinning space of an electric field of high intensity the nanofibres produced through electrostatic spinning of polymer matrix are deposited. Through the spinning space of the electric field at least two straight segments of the linear fibre core are guided, between which the core outside the spinning space of electric field is guided at least along a section of circumference of the guiding cylinder, while in projection into a plane being tangential to circumference of the guiding cylinder and passing the respective segment of the core, this segment of the core and longitudinal axis of the guiding cylinder contain an acute angle.

### TECHNICAL FIELD

The invention relates to a linear fibre formation comprising nanofibres deposited on a linear fibre core.

The invention further relates to a method of production of the linear fibre formation comprising the linear fibre core, on which in a spinning space of an electric field of high intensity the nanofibres produced through electrostatic spinning of polymer matrix are deposited.

The invention also relates to a device for production of linear fibre formation comprising the linear fibre core, on which there are deposited the nanofibres produced through electrostatic spinning of polymer matrix in the spinning space of electric field created between a spinning electrode and a collecting electrode, which, are, arranged opposite to each another in an active chamber.

### BACKGROUND ART

To date there were developed several methods for production of nanofibres, i.e. fibres having diameter under 1 micrometer, which are based on various physical or chemical processes. The most important of them and at present also the only industrially applicable is electrostatic spinning of solutions or melts of polymers, during which the nanofibres are formed by action of force of electric field induced between a collecting electrode and a spinning electrode of an elongated shape from solution or melt of polymer being present in the electric field on surface of this spinning electrode. According to EP 1673493 the spinning electrode is formed of rotating elongated body; according to WO 2009010020 it comprises static or in direction of its length moveable spinning element having shape of a cord.

Planar layer of mutually interlaced nanofibres is typical product of electrostatic spinning. This in combination with further supporting or covering layers has a number of applications, especially in the sphere of filtration and hygienic means, nevertheless for many further applications it could be utilised only in a restricted range, or even not at all. These applications in their principle require more likely linear formations formed of nanofibres, possibly more complicated spatial structures prepared by further processing of such linear formations.

In this sense, in the US 2008265469 there was proposed a method for production of nanofibrous yarn through direct drawing down of nanofibres from several couples of oppositely arranged nozzles charged with opposite electric charge and their subsequent binding. Nevertheless this method is able to achieve only a low output, which moreover will not be constant due to mutual affecting of electric fields of individual nozzles. The resultant linear formation, if it is ever created, will be of non-uniform structure with minimum tensile strength. This method and through it prepared linear formation is thus suitable only for an experimental use in laboratory.

US 20090189319 discloses a method for production of linear formation formed of nanofibres by twisting the planar layer of nanofibres. Also such prepared linear formation features a minimum tensile strength and is not suitable for any practical application. Method of twisting of planar layer of nanofibres is moreover rather technologically complicated and lengthy, at the same time it achieves only low outputs, so that it is applicable in limited laboratory scale only.

Another possibility how to prepare the linear nanofibrous formation is to utilise the collecting electrode according to WO 2009049564, which in one of described variants comprises system of singular electric charges arranged on an abscissa, or on a circumference of a rotating disc. The created nanofibres in preference deposit along these singular charges, thus creating a linear formation on the collecting electrode. Its tensile strength may be higher than that of formations prepared by some of the previous methods, but still not small achievable length of the linear nanofibrous formation limited by maximum length of the collecting electrode. Due to this, either this method cannot be successfully utilised in an industrial scale.

To achieve the required tensile strength and improvement of further mechanical properties, there were further proposed several methods for preparation of linear textile formation, which comprises a core formed of a thread, yarn or similar linear textile formation, on which a coating formed of nanofibres is deposited. The core at the same time enables among others mechanical processing of this formation through common textile techniques, while the coating should grant to it advantageous properties of nanofibres particularly based on their morphology, such as e.g. a high specific surface, excellent sorptive properties, small size of spaces between the fibres, etc.

Method for preparation of such linear textile formation, at which the core is coiled around with a narrow planar layer of nanofibres, was described in WO 2008095239. By mere depositing of planar layer of nanofibres on the core there is still not guaranteed their sufficiently resistant connection, and the layer of nanofibres is torn off in principle at any subsequent manipulation. Yet the most important shortcoming of this procedure is complicated, if not totally impossible, preparation of applicable planar layer of nanofibres. This, due to its small strength, nearly at any manipulation tears to small fragments, which thanks to their large surface join into tufts and/or they get stuck on surrounding objects. Upon using any available technical means in any case it is not possible to ensure continual delivery of planar layer of nanofibres to the core and creating of even and continuous coating. This procedure thanks to its technological demanding and unreliability is not suitable for industrial utilisation and it can be used for research purposes only.

These and further shortcomings should have been eliminated by a method disclosed in WO 2008106904, at which the nanofibres are applied on the core formed of a thread or a yarn immediately after their creation through electrostatic spinning. The core, before applying the nanofibres, is imparted by a false twist, during whose creating and subsequent elimination the nanofibres nevertheless revealed, that mechanical fastening of nanofibres on the core is insufficient for further processing. Next shortcoming of this procedure is relatively low output of electrostatic spinning caused especially by concentration of electric field in vicinity of the core. This results in total or partial elimination of electric charge of nanofibres and change of their trajectory in the electric field, due to which the majority of nanofibres deposit outside the core surface. Though this method reaches the highest output of all the known solutions, and by it prepared linear formation achieves the most convenient properties, their real industrial applicability is very limited.

The goal of the invention is to eliminate or at least to reduce the disadvantages of the background art by proposing a device and a method for production of linear textile formation comprising the nanofibres, which would be industrially applicable, and which would enable independent applicability of the prepared linear textile formation, possibly its further processing through common textile techniques.

### PRINCIPLE OF THE INVENTION

The goal of the invention has been achieved through a linear fibre formation comprising nanofibres deposited on a linear fibre core which are to it fixed with a coil of at least one covering thread. The coil of covering thread ensures sufficient strong and resistant deposition of nanofibres on the core for majority of considered applications, and simultaneously enables to fully use the specific properties of nanofibres, of their material or compounds deposited in their material, as it does not present access to them.

Yet stronger and more resistant deposition is achieved when the nanofibres are fixed to the core with a coil of two covering threads coiled in mutually opposite sense.

Simultaneously with a coil of one or two covering threads also another type of fixation may be used, this either a heat fixation and/or mechanical fixation by means of a suitable binder.

Next to this, the goal of the invention has been also achieved by a method for production of linear fibre formation comprising a linear fibre core, on which in the spinning space of electric field of high intensity the nanofibres produced through electrostatic spinning of polymer matrix are deposited. Principle of this method consists in that, through the spinning space of electric field at least two straight segments of the linear fibre core are guided, between which the core is guided outside the spinning space of the electric field at least along a section of circumference of the guiding cylinder, while in projection into a plane being tangential to circumference of the guiding cylinder and passing the respective segment of the core, this segment of the core and longitudinal axis of the guiding cylinder contain an acute angle. Thanks to this guidance the whole circumference of the core is exposed to the approaching nanofibres gradually, possibly also repeatedly, and nanofibres create on the core the required continual and uniform layer.

From aspect of industrial applicability, it is more advantageous, if the core is guided outside the spinning space at least on a section of circumference of two guiding cylinders arranged on opposite sides of the spinning space, while their longitudinal axes are mutually intersecting. In projection into a plane being tangential to circumference of the guiding cylinder and passing the respective segment of the core, this segment of the core and longitudinal axis of corresponding guiding cylinder contain an acute angle. In this manner it is possible to guide through the spinning space of electric field according to the need, whatever quantity of straight segments of the core.

In further preferred variant the longitudinal axes of guiding cylinders are mutually skew.

To increase the quantity of nanofibres caught on the linear fibre core it is possible to apply on it, before its entry into the spinning space of the electric field, an electrically conducting liquid, through which its electric conductivity is increased. Subsequently the core in the spinning space and/or outside the spinning space is grounded, thanks to which an electric charge which is induced on it and/or which is on it applied by nanofibres is lead off, so that no unwilling

Increasing of electric conductivity of the core simultaneously enables electrostatic spinning without using the collecting electrode, while the electric field, in whose spinning space on the core through electrostatic spinning of polymer matrix the nanofibres are depositing, is induced between the spinning electrode and the electrically conductive core. The core behaves as a collecting electrode.

For further depositing and processing of created linear fibre formation comprising the nanofibres it is advantageous, if from the core with increased electrical conductivity after exiting from the spinning space of electric field, at least part of electrically conducting liquid is removed.

Most of applications further requires fixation of nanofibres to the core by heat or mechanical fixation performed after exiting from the spinning space of the electric field, possibly by their combination.

The most suitable method of mechanical fixation is coiling with at least one covering thread, possibly with two covering threads coiled in mutually opposite sense.

Next to this, the goal of the invention has been further achieved by a device for production of the linear fibre formation comprising the linear fibre core, on which the nanofibres produced through electrostatic spinning of polymer matrix in the spinning space of the electric field induced between a spinning electrode and a collecting electrode are deposited. In active chamber there is created a guidance of linear fibre core, that comprises guiding cylinder arranged outside the spinning space of electric field, while through the spinning space of electric field at least two straight segments of linear fibre core are guided, between which the core is guided at least on a section of circumference of the guiding cylinder, and in projection into a plane being tangential to circumference of the guiding cylinder and passing the respective segment of the core, the core and longitudinal axis of the guiding cylinder contain an acute angle. Thanks to this guidance of linear fibre core the nanofibres may deposit along its whole circumference.

cylinders arranged outside the spinning space of the electric field on its opposite sides. Longitudinal axes of guiding cylinders are mutually intersecting, and the linear fibre core is guided at least on section of circumference of both guiding cylinders, and in projection into a plane being tangential to circumference of guiding cylinder and passing the respective segment of the core and longitudinal axes of guiding cylinders contain an acute angle.

In further variant the longitudinal axes of guiding cylinders are mutually skew.

To reach a higher capture of nanofibres on the linear fibre core, it is further advantageous if the electric field is induced between the spinning electrode and electrically conductive linear fibre core. To increase electric conductivity of the core an applying unit for applying of electrically conducting liquid is arranged in front of its first entry into the spinning space of the electric field.

Due to the fact that for stocking the linear fibre formation comprising nanofibres and its further processing it is advantageous if at least a part of electrically conducting liquid is removed from it, after its last exit from the spinning space of the electric field there is arranged a device for removing of at least part of electrically conducting liquid from the linear fibre core. Here is also arranged a device for mechanical and/or heat fixation of nanofibres to the linear fibre core. Preferably this, is a device for its coiling with at least one covering thread, possibly device for its coiling with two covering threads.

### DESCRIPTION OF THE DRAWING

Principle of the invention will be explained referring to the enclosed drawing, where the

FIG. 1 schematically represents a cross section of an active chamber of a device for production of linear fibre formation comprising nanofibres, the

FIG. 2 a top view to guidance of a linear fibre core in the spinning space of the device according to the FIG. 1, the

FIG. 3 a cross section through an active chamber of a device for production of linear fibre formation linear fibre core in the spinning space of the device according to the FIG. 3, the

FIG. 5 a cross section through an active chamber of a device for production of linear fibre formation comprising nanofibres in further variant, the

FIG. 6 a cross section of a device for fixation of nanofibres to the core of linear textile formation, the

FIG. 7a one of preferred variants of embodiment of the linear fibre formation comprising the nanofibres according to the invention, and the FIG. 7b another of preferred variants of embodiment of this linear fibre formation.

### EXAMPLES OF EMBODIMENT

Device according to the invention for production of a linear fibre formation comprising a linear fibre core, on which the nanofibres are deposited, comprises active chamber 1, in which there is performed production of polymer nanofibres through electrostatic spinning of a liquid polymer matrix—solution or melt of polymer, and their depositing on the suitable linear substrate. Polymer matrix may comprise one or more suitable additives, which in a desired manner affect properties of produced nanofibres, such as e.g. metals, salts or other low-molecular substances, their precursors, etc.

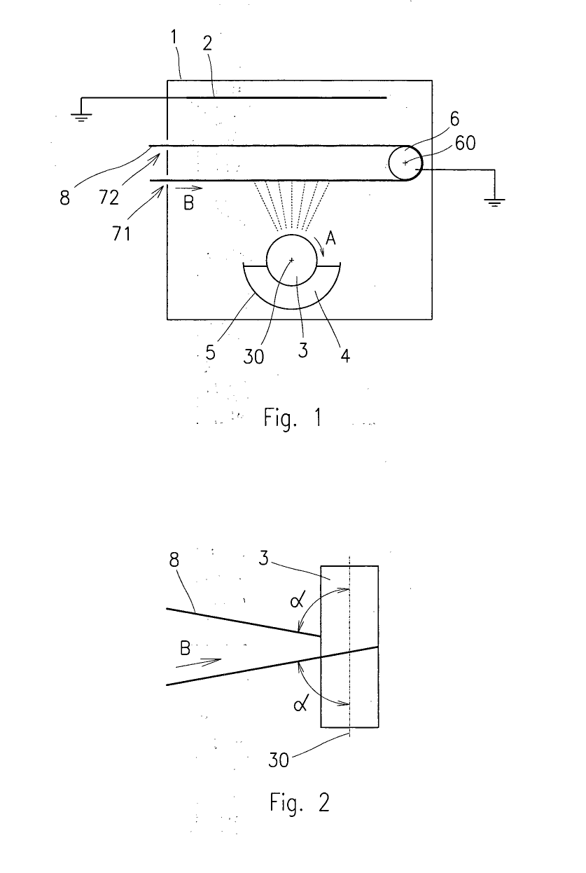

In embodiment of the device in the FIG. 1 in upper part of the active chamber 1 there is statically mounted collecting electrode 2 formed of electrically conductive plate. In lower part of the active chamber 1 under the collecting electrode 2 there is rotatably mounted spinning electrode 3 formed of cylinder, which with section of its circumference extends into the polymer matrix 4 positioned in the reservoir 5. The spinning electrode 3 is coupled with not represented drive for rotational motion around longitudinal axis in direction of arrow A. The spinning electrode 3 and the collecting electrode 2 are further connected with opposite poles of not represented source of high direct-current voltage, possibly one of them is grounded, by which electric field of high intensity is induced between them. One of possible variants how to bring electric charge to the spinning electrode 3 is its bringing into the polymer matrix 4 in the reservoir 5.

the nanofibres from layer of the polymer matrix on surface of the spinning electrode 3 are formed and carried towards the collecting electrode 2.

Outside the spinning space of the electric field in the active chamber 1 the grounded guiding cylinder, 6 made of electrically conducting material is arranged freely rotatably. The guiding cylinder 6 together with a feeding hole 71 and a offtake hole 72 made in the wall of the active chamber 1, create guidance of linear fibre core 8, which serves as substrate for depositing of nanofibres and creates the core of the linear fibre formation comprising nanofibres according to the invention. Linear fibre core 8 is guided into the active chamber 1 through the feeding hole 71, and through the spinning space of the electric field it is guided to lower section of circumference of the guiding cylinder 6. On outer section of its circumference the linear fibre core 8 is guided to upper section of circumference of the guiding cylinder 6, from where through the spinning space of electric field and through the offtake hole 72 it is guided out of the active chamber 1. Outside the active chamber 1 the linear fibre core 8 is coupled with not represented winding and/or take-up mechanism, that ensures its motion in the active chamber 1 in direction of arrow B. In this manner through the spinning space of electric field two straight segments of the linear fibre core 8 are guided, which are laying in parallel planes tangential to the guiding cylinder 6. As it is obvious from the FIG. 2, each of the direct segments of linear fibre core 8 in projection into this plane and longitudinal axis 60 of the guiding cylinder 6 contain an acute angle α.

Achieving of desired angle α is ensured through mutual position of the feeding hole 71 and the offtake hole 72 and/or position or displacement of the guiding cylinder 6 towards them, and/or by means of not represented guiding elements of the linear fibre core 8 arranged in the active chamber 1. Simultaneously it is advantageous, if mounting of the guiding cylinder 6 enables change of position and/or inclination of the guiding cylinder 6, thus adjustment of suitable size of angle α, e.g. in dependence on actual conditions in the electric field and/or type of the polymer matrix 4 and/or other factors.

In further not represented examples of embodiment the straight manner, in mutually intersecting planes, which intersect in the spinning space, or outside it. In any case, for correct function it is necessary to ensure by means of some of above mentioned manners presence of the acute angle α between the straight segments of the linear fibre core 8 and the longitudinal axis 61 of the guiding cylinder 6 in projection into a plane being tangential to circumference of the guiding cylinder 6 and passing given straight segment of the linear fibre core 8.

Using any of these methods, possibly of their combinations, in further not represented variants, it is possible to guide several linear fibre cores 8 of the same or various type through the spinning space of the electric field in parallel.

Suitable linear fibre core 8 is e.g. a thread of any type, or other linear fibre formation, such as e.g. a yarn, a filament, a fibrous or micro-fibrous cable, etc. At usage of the filament it is advantageous, if its surface is in a suitable manner modified for increasing the adhesiveness of applied nanofibres to it.

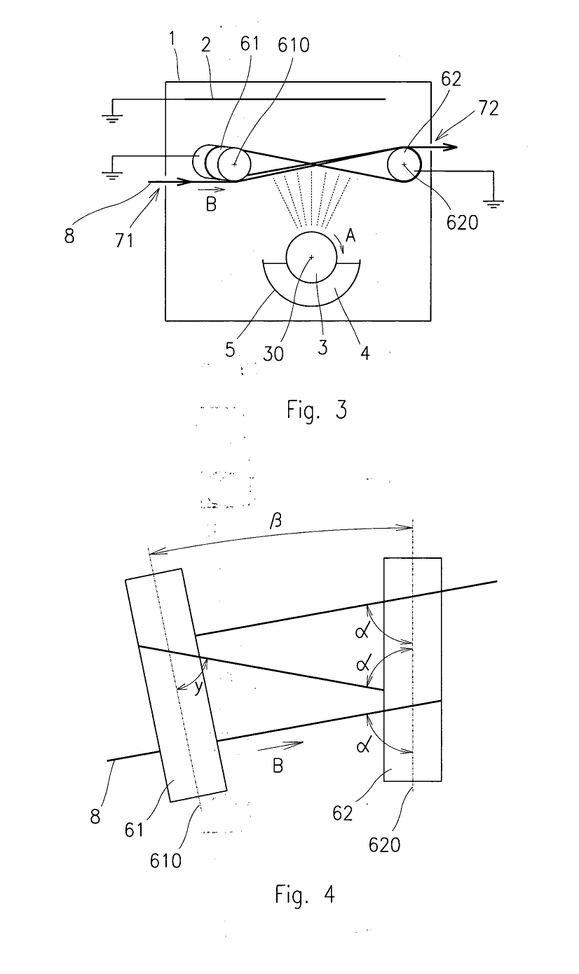

The FIG. 3 represents further variant of device according to the invention, which from the variant represented in the FIG. 1 differs especially by manner of guiding the linear fibre core 8 in the active chamber 1 and by number of its straight segments in the spinning space of the electric field. At this embodiment in the active chamber 1 outside the spinning space of the electric field there are mounted two identical guiding cylinders 61 and 62, arranged on opposite sides of the spinning space. Both guiding cylinders 61 and 62 are made of electrically conductive material and are grounded. Their longitudinal axes 610 and 620 lie in a common plane, which is in the represented example of embodiment parallel with collecting electrode 2, and they are mutually intersecting, so that they together in this plane contain an acute angle β (FIG. 4). In the preferred construction embodiment mounting of at least one of the guiding cylinders 61 and 62 enables change of actual size of angle β and adjustment of its required value, this either during shut-down of the device or preferably during its operation.

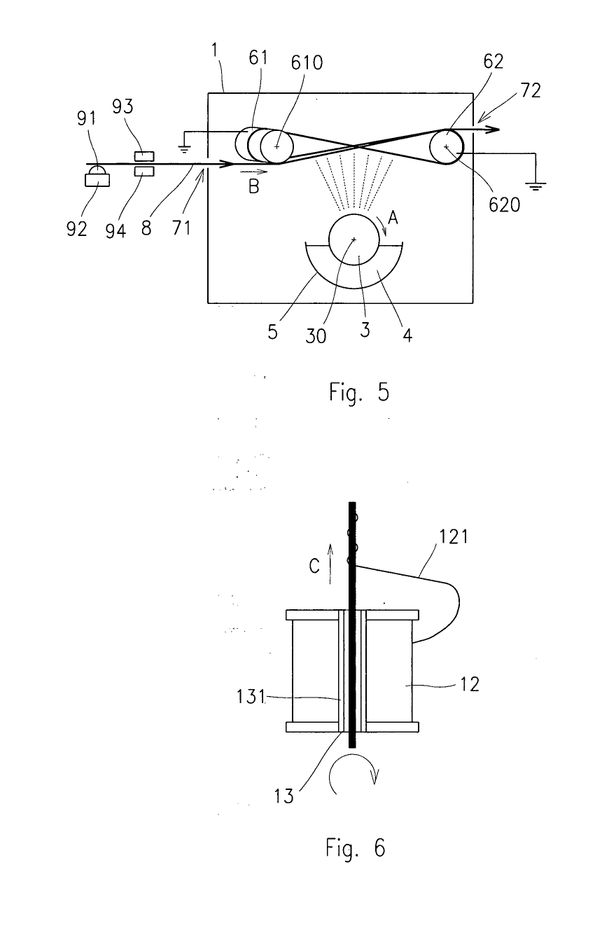

In another not represented example of embodiment the longitudinal axes 610 and 620 of guiding cylinders 61 and 62 may be mutually skew, while the acute angle β they contain in projection into the respective plane, which is in case of positioning the guiding cylinders 61 and 62 side by side (embodiment represented in the FIG. 3 and FIG. 5) any horizontal plane, and in case of positioning the guiding cylinders 61 and 62 one under another any vertical plane.

Linear fibre core 8 in the represented example of embodiment is guided into the active chamber 1 through the feeding hole 71, and in front of entry into the spinning space of the electric field it is guided on a lower section of circumference of the first guiding cylinder 61. From here it is through the spinning space of electric field guided to upper section of circumference of the second guiding cylinder 62, and on outer section of its circumference it is guided to lower section of circumference of the second guiding cylinder 62. From here, through the spinning space of electric field it is further guided to upper section of circumference of the first guiding cylinder 61. On the outer section of its circumference the linear fibre core 8 is guided to lower section of circumference of the first guiding cylinder 61, from where it is again through the spinning space of electric field guided to upper section of circumference of the second guiding cylinder 62, and by means of the offtake hole 72 out of the active chamber 1. Outside the active chamber 1 the linear fibre core 8 is coupled with not represented winding and/or take-up mechanism, which ensures its motion in active chamber 1 in direction of arrow B. In this manner through the spinning space of electric field three straight segments of the linear fibre core 8 are guided, out of which the first and the third in order are mutually parallel, and the second segment of the linear fibre core 8 arranged between them is intersecting towards them (FIG. 4). As it is apparent from the FIG. 4, in order the first and the third straight segment of the linear fibre core 8 in projection into a plane being tangential to the second guiding cylinder 62 and passing through one of these straight segments and longitudinal axis 620 of the second guiding cylinder 62 contain the acute angle α. At the same time, in order the second straight segment of the linear fibre core 8 forms in projection into a plane being tangential to the second guiding cylinder 62 and passing through the second straight segment with longitudinal axis 620 of the second guiding cylinder 62 also the same acute angle α. The second segment then further contains in projection into the plane being tangential to the first guiding cylinder 61 and passing through the second straight segment with longitudinal axis 610 of the first guiding cylinder 61 the acute angle γ, while as apparent from the FIG. 4, γ=α−β. By this manner of guidance between the first and third straight segments of linear fibrous core 8 there is created a spacing b, whose size is function of angle β, and its value is adjustable depending on it. At constant value of angle β during operation of the device, also the size of the spacing b is constant.

Length of individual straight segments of the linear fibre core 8 is thanks to intersecting position, possibly thanks to skew position of longitudinal axes 610 and 620 of guiding cylinders 61 and 62 not identical, and in the represented example of embodiment in direction of motion of the linear fibre core 8 indicated by arrows B is increasing.

Like in the previous variant of device represented in the FIG. 1 and FIG. 2 the guidance of the linear fibre core 8 also in this variant may further be provided with further not represented guiding means for adjustment of direction of guidance and/or improvement of guidance and/or reduction of friction, etc.

At both described variants the spinning electrode 3 rotates around its longitudinal axis 30, and on, its surface carries into the electric field between the spinning electrode 3 and the collecting electrode 2 a layer of polymer matrix 4. In the spinning space of this electric field thanks to force action of the electric field this layer of polymer matrix 4 is deformed and so called Taylor cones are created, out of which in a known method the nanofibres are elongated. These nanofibres, also thanks to force action of the electric field, move in direction to the collecting electrode 2, and are mechanically caught on straight segments of linear fibre core 8. The linear fibre core 8 is simultaneously by the take-up mechanism drawn off in direction of its length (arrow B), while its guidance via the guiding cylinder 6 (61, 62) under the acute angle α (γ) moreover causes its rolling on surface of the guiding cylinder 6 (61, 62), so that the linear fibre core 8 simultaneously rotates around its longitudinal axis. The whole circumference of the linear fibre core 8 is gradually, possibly repeatedly, being exposed to approaching nanofibres, and the nanofibres create continual layer on it. Due to core 8 has an opposite sense than in the previous one, additional false twist is not created on it, or this false twist is negligible and can be easily eliminated.

Number of rotations of the linear fibre core 8 around its longitudinal axis in individual straight segments may be increased or vice versa reduced by changing the angle β contained between longitudinal axis 610, 620 of guiding cylinders 61, 62 (respectively by turning the guiding, cylinder 6 towards guidance of the linear fibre core 8), by their mutual distance. Intersecting, possibly skew running of longitudinal axis 610 and 620 of guiding cylinders 61 and 62 simultaneously ensures creating and keeping of the above mentioned spacing b between straight segments of the linear fibre core 8 guided through the spinning space of electric field. Actual size of spacing b is function of the angle β contained between longitudinal axes 610 and 620 of guiding cylinders 61 and 62, and substantially affects the quantity of nanofibres caught on the linear fibre core 8 and their distribution on it. At small value of spacing b all straight segments of linear fibre core 8 behave as a planar obstacle, and the approaching nanofibres simultaneously deposit on two, possibly even more straight segments, while they tend to create a planar layer on them. This layer nevertheless at moving of neighbouring straight segments of linear fibre core 8 in opposite direction tears and the nanofibres agglomerate into tufts. On the contrary, at overly high value of spacing b plurality of nanofibres passes between individual straight segments of the linear fibre core 8 without getting into contact with them, and they deposit directly on the spinning electrode 2. Nanofibres, which in spite of this are caught on the linear fibre core 8, do not create required continual and even layer on it. Thus an overall performance of the device is reduced significantly, while the nanofibres which deposit on the collecting electrode 2 require regular shut-downs of the device and technologically complicated removal. By changing the angle β the value of spacing b may be directly set according to the type of used polymer matrix 4 and/or parameters of electric field and/or diameter of used linear fibre core 8 and/or actual behaviour of nanofibres in the spinning space of the electric field, etc. Upon setting of the suitable size of spacing b (units to tens of mm) the quantity of nanofibres Caught on surface of linear fibre core 8 and their distribution on it may be further controlled by speed of taking-up the linear fibre core 8 and/or by guiding the required number of its straight segments in the spinning space of the electric field. The number of these segments may be up to several tens, this in dependence on strength of the used linear fibre core 8.

The result of the whole process, in all variants of the device, is a linear fibre formation comprising nanofibres according to the invention, which comprises the linear fibre core 8, on which a coating formed of layer of nanofibres is deposited. Linear fibre core 8 grants to this formation sufficient tensile strength, and the coating thanks to morphology of nanofibres high specific surface, excellent filtration and sorptive properties, or further specific properties arising from morphology of nanofibres and/or their material. This linear fibre formation comprising nanofibres definitely finds numerous utilisations in applications, where it is not excessively mechanically stressed, which would cause tearing off the nanofibre layer from the linear fibre core 8, i.e. especially in the sphere of cultivation of cells and/or bacteria or in the sphere of filtration with low speed of filtrated media, etc.

The FIG. 5 represents further embodiment of the device for production of the linear fibre formation comprising nanofibres according to the invention. Arrangement of elements of this device is nearly identical as at previous embodiment, with the difference that in structure of the device the collecting electrode 2 is totally omitted, and in direction of motion of the linear fibre core 8 in front of the active chamber 1 there is positioned unit 9 for increasing of electric conductivity of the linear fibre core 8, through which the linear fibre core 8 passes. This unit 9 consists of rotatably mounted applying cylinder 91, which with section of its circumference extends into the reservoir 92 with liquid conducting solution and which is in contact with the linear fibre core 8, and of two planar spreading plates 93 and 94, out of which at least one is pressed against the second, while the linear fibre core 8 is guided through the gap between them. Sections of spreading plates 93 a 94, which are in contact with the linear fibre core 8, are preferably provided with textile surface or other suitable surface finish, which reduces danger of mechanical damage of the linear fibre core 8 and simultaneously enables spreading of electrically mounted either freely rotatably, or it is coupled with not represented drive for rotational motion, while by controlling the speed of its rotation may be controlled quantity of electrically conducting solution applied on the linear fibre core 8, thus also the achieved electric conductivity. In other not represented examples of embodiment the applying unit 9 may be created structurally and/or in principle differently, nevertheless its variants are obvious to the person skilled in the art, therefore they will not be described herein. Electrically conducting solution may in other variants be applied to the linear fibre core 8 e.g. in the form of aerosol and/or steam, etc.

Between the applying unit 9 and the spinning space 1 there is with advantage included not represented sensor of electric conductivity, which serves especially for verifying the electric conductivity of the linear fibre core 8 with applied electrically conducting solution. Nevertheless utilisation of such sensor is not necessary for correct function of the device according to the invention, and so its structure or type will not be described herein, nor method of evaluation of the data acquired from it. Moreover these facts are quite obvious to the person skilled in the art.

The device for production of the linear fibre formation comprising nanofibres according to the invention represented in the FIG. 5, but also in the FIG. 3, may in further not represented variants be modified by usage of guiding cylinders 61, 62 of various diameters.

During taking-up of the linear fibre core 8 in direction of arrow B, by means of the applying cylinder 91, electrically conducting solution is applied on it which subsequently during passage between the spreading plates 93 and 94 is evenly spread on its surface. Through this electrical conductivity of the linear fibre core 8 is increased above its usual, generally negligible value, and the linear fibre core 8 after then, behaves as an electric conductor. Thanks to this, it is by means of the grounded guiding cylinders 61 and 62 an/or other not represented means positioned in the spinning space of electric field and/or outside it grounded. As a result of this, between the linear fibre core 8 and the spinning electrode 3, which is connected with one pole of not represented intensity, in whose spinning space electrostatic spinning of liquid polymer matrix 4 is performed on surface of the spinning electrode 3 in the same manner as in the previous examples of embodiment. The nanofibres created are attracted directly to the grounded linear fibre core 8, which de facto represents the collecting electrode 2. Thanks to this the transit of nanofibres between its straight segments is substantially zero even at relatively high values of the spacing b, so that considerably greater quantity of nanofibres deposits on its surface than at usage of variant of device represented in the FIG. 1 or in the FIG. 3. Moreover the nanofibres get stuck to the linear fibre core 8 more tightly, while they may partially also penetrate into its internal structure. In this manner the layer of nanofibres is to the linear fibre core 8 connected in principle more tightly and in more resistant manner than in previous examples of embodiment, which enables usage of such prepared linear fibre formation comprising nanofibres also in applications, where it is exposed to mechanical stress or friction.

By increasing the conductivity of the linear fibre core 8 and by its grounding, carrying away of charges brought to it by electrically charged nanofibres is ensured and simultaneously also of electric charges, which induce or may induce on the linear fibre core 8, so that during operation there is no fluctuation of intensity of the electric field and the output of the device is thanks to this maintained substantially constant. Guidance of the linear fibre core 8 over surfaces of guiding cylinders 61 and 62, and its possible rolling at the same time ensures even and continuous applying of nanofibres on its entire circumference.

Based on number of experiments there was specified an optimum value of electric conductivity of the linear fibrous core 8 with electrically conductive solution in the range of c. 10-1500 nS/20 mm (measuring of electric conductivity during experiments was performed on segment of thread having length of 20 mm), possibly also more, at the same time it is obvious, that at lower values a lower output of spinning is achieved, and vice versa at higher values a higher output of spinning is achieved. To increase the electric conductivity of linear fibre core 8 at these experiments a water solution of electrolyte with addition of required value of electric conductivity, for cellulose threads usually smaller quantity of electrically conductive solution is sufficient, than for the synthetic threads which feature a worse wettability.

In further variants, for increasing of conductivity of the linear fibre core 8 any other electrically conductive solution may be used, which generally contains sufficient quantity of electrolyte and surface active substance. Due to the fact that the linear fibre core 8 after applying the electrically conductive solution is in contact with metal guiding cylinders 61 and 62, and possibly also with other metal parts, it is preferred if such electrically conductive solution is used, which does not cause corrosion of these elements. Of course, for their production some non-corroding material may be used, but herewith acquisition costs of the device according to the invention are increased, without bringing any further technological advantage.

In further variants of the device for production of the linear fibre formation comprising the nanofibres according to the invention instead of grounding of the linear fibre core 8 with increased electric conductivity, it is possible to connect this linear fibre core 8 with one pole of source of high direct-current voltage. It is necessary to select polarity and value of high direct-current voltage so that between the linear fibrous core 8 and the spinning electrode 3 an electric field is induced, in whose spinning space creating of Taylor cones and elongation of nanofibres occurs, as well as the required motion of nanofibres in direction to the linear fibrous core 8.

Further important variant of the device for production of the linear fibre formation comprising nanofibres according to the invention is achieved by combination of variants represented in the FIG. 3 and FIG. 5. Such a variant consists in simultaneous usage of the collecting electrode 2 as well as the linear fibre core 8 with increased electric conductivity. To the collecting electrode 2 and to the linear fibre core 8 there may be brought electric charge of the same or different polarity and value, possibly the collecting electrode 2 and/or linear fibre core 8 may be grounded. This structural arrangement enables especially more precise control and/or adjustment of parameters of the electric field.

In all represented and described variants of embodiment of the device according to the invention through the spinning space of the electric field in principle any number of straight segments of linear fibre core 8 may be guided, so that depositing of desired quantity of nanofibres on its surface is achieved. At the same time, the minimum number is two straight segments. The maximum number of straight segments is in principle limited only by tensile strength of used linear fibrous core 8 and by number of nanofibres applied to it, and it may vary in order of tens, possibly it may exceed even one hundred. In variant where electrically conducting solution is applied to the linear fibre core 8 before its entry into the spinning space, the intensity in depositing of nanofibres thanks to drying of conducting solution gradually decreases, thus using of extremely high number of straight segments of linear fibre core 8 is not efficient. Drying of the conductivity increasing solution may be prevented by additional applying of conductivity increasing solution outside the spinning space, e.g. on circumference of some of the guiding cylinders 6, 61, 62. Due to relatively high space demand of the winding and take-up device of the linear fibre core 8 it is preferred to use an odd number of straight segments, which enables advantageous arrangement of each of these devices on opposite side of active chamber 1. An even number of straight segments of the linear fibre core 8 is however also usable in reality.

All described embodiments of device for production of the linear fibre formation comprising nanofibres may further be, structurally modified by usage of other types of collecting or spinning electrodes 2, 3. As the collecting electrode 2 in further structural variants there may be used e.g. thin-walled cylinder according to WO 2008011840, etc. As the spinning electrode 3 there may be utilised in principle any spinning electrode 3 formed of elongated body rotating around its longitudinal axis, e.g. according to WO 2005024101 or according to WO 2006131081, of body having shape of a cord according to WO 2009010029 or according to CZ 2008-217, possibly also nozzle (capillary) or of a system of nozzles (capillaries), which nevertheless shows known shortcomings.

The prepared linear fibre formation comprising nanofibres finds number of applications, nevertheless for most of applications it is advantageous, if the nanofibres are to the linear fibre core 8 after exiting from the spinning space of electric field additionally fixed by some of known methods. The most suitable means of fixation is heat shrinkage of nanofibres.

Before the fixation itself it is advantageous, if from the linear fibre formation comprising nanofibres, any possible remnants of electrically conductive solution are removed.

The best results are achieved at fixation of nanofibres to the linear fibre core 8 by coiling around with at least one covering thread. To this purpose there serves e.g. device schematically represented in the FIG. 6, which comprises the reel 12 of covering thread 121 rotatably mounted on the hollow spindle 13. Through the cavity 131 of the spindle 13, which is preferably a static one, nevertheless may be also rotatable simultaneously with the reel 12, there is guided the linear fibre core with deposited nanofibres, which is coupled with not represented take-up and winding mechanism, ensuring its motion in direction of arrow C.

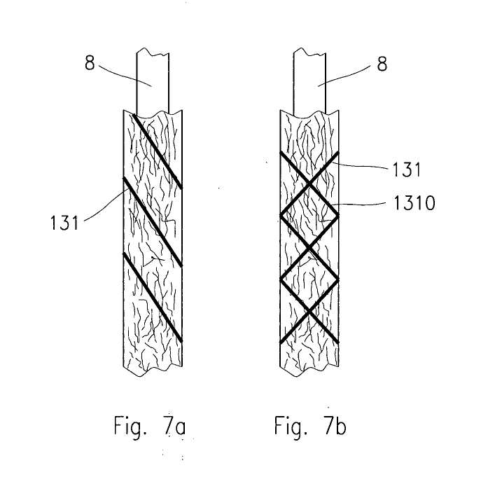

During rotation of the reel 12 the linear fibre formation comprising nanofibres is coiled around with the covering thread 121 which on it, thanks to its simultaneous taking-up, creates a regular screwline. Though the covering thread 121 covers part of surface of nanofibres, which is when compared with total specific surface of nanofibres negligible part, and the preferred properties of the linear fibre formation comprising nanofibres, which arise out of morphology of nanofibres and/or their material remain in principle unaffected. The covering thread 121 moreover does not prevent access of surrounding media to nanofibres positioned under it, nor possible action and/or releasing of additives contained in them. Structure of the resultant linear formation comprising nanofibres is schematically represented in the FIG. 7a.

From an aspect of overall resistance, for some applications it is still more advantageous if the linear fibre formation comprising nanofibres is simultaneously coiled around with two covering threads 121, 1210 coiled in mutually opposite sense—the FIG. 7b.

In praxis with good results there may be combined coiling around of the linear fibre formation comprising nanofibres with at least one covering thread 121 with other types of fixation performed before coiling around and/or after it, especially with fixation by binders.

The linear formation comprising nanofibres according to the invention coiled around by one or two (possibly also more) covering threads 121 (1210) may further be processed using common textile techniques, and incorporated into textiles, both into technical textiles and textiles designated for production of clothes, etc. This enables considerably greater utilisation of advantageous properties of nanofibres than to date, while the nanofibres may further be adjusted for particular application, e.g. by incorporating of nanoparticles of silver or other suitable substance into their material, or through a suitable selection of material of nanofibres or combination of several types of material, etc.

### LIST OF REFERENTIAL MARKINGS

1 active chamber
2 collecting electrode
3 spinning electrode
30 longitudinal axis of spinning electrode
4 polymer matrix
5 reservoir of polymer matrix
6 guiding cylinder
60 longitudinal axis of guiding cylinder
61 first guiding cylinder
610 longitudinal axis of first guiding cylinder
62 second guiding cylinder
620 longitudinal axis of second guiding cylinder
71 feeding hole
72 offtake hole
8 linear fibre core
9 applying unit
91 applying cylinder
92 reservoir of electrically conducting solution
93, 94 spreading plate
12 reel of covering thread
121, 1210 covering thread
13 spindle
131 spindle cavity
A, B, C motion direction
α,β, γ contained angles
b spacing

1. A linear fibre formation comprising nanofibres deposited on a linear fibre core, wherein the nanofibres are to the core fixed with a coil of at least one covering thread.

2. A linear fibre formation according to claim 1, wherein the nanofibres are to the core fixed with a coil of two covering threads coiled around in mutually opposite sense.

3. A linear fibre formation according to claim 1, wherein the nanofibres are to the core fixed by a heat fixation and/or a binder.

4. A method for production of a linear fibre formation comprising a linear fibre core, on which in a spinning space of an electric field of a high intensity the nanofibres produced through electrostatic spinning of polymer matrix are deposited, wherein through the spinning space of the electric field at least two straight segments of the linear, fibre core are guided, between which is the core outside the spinning space of electric field guided at least along a section of circumference of a guiding cylinder, while in projection into a plane being tangential to circumference of the guiding cylinder and passing the respective segment of the core this segment of the core and longitudinal axis of the guiding cylinder contain an acute angle.

5. A method according to claim 4, wherein the core is guided outside the spinning space at least on a section of circumference of two guiding cylinders arranged on opposite sides of the spinning space, while axes of guiding cylinders are mutually intersecting, and in projection into a plane being tangential to circumference of the guiding cylinder and passing the respective segment of the core this segment of the core and longitudinal axis of corresponding guiding cylinder contain an acute angle.

6. A method according to claim 4, wherein the core is guided outside the spinning space on at least a section of circumference of two guiding cylinders arranged on opposite sides of the spinning space, while axes of guiding cylinders are mutually skew, and in projection into a plane being tangential to circumference of the guiding cylinder and passing the respective segment of the core this segment of the core and longitudinal axis of corresponding guiding cylinder contain an acute angle.

7. A method according to claim 1, wherein before its entry into the spinning space of electric field, on the core there is applied electrically conducting liquid, through which electric conductivity of the core is increased, while the core with increased electric conductivity is grounded in the spinning space and/or outside it.

8. A method according to the claim 7, wherein the electric field, in whose spinning space on the core through electrostatic spinning of polymer matrix the nanofibres are deposited, is induced between the electrically conducting core and the spinning electrode.

9. A method according to claim 7, wherein from the core with increased electrical conductivity after exiting from the spinning space of electric field, at least part of electrically conducting liquid is removed.

10. A method according to claim 4, wherein the nanofibres after exiting from the spinning space of electric field are fixed to the core by heat and/or by coiling around of at least one covering thread.

11. A method according to claim 4, wherein the nanofibres after exiting from the spinning space of electric field are fixed to the core by coiling around with two covering threads, which are coiled around in mutually opposite sense.

12. A device for production of a linear fibre formation comprising a linear fibre core, on which there are deposited the nanofibres produced through electrostatic spinning of polymer matrix in a spinning space of electric field induced between a spinning electrode and a collecting electrode, which are arranged opposite to each other in an active chamber, wherein in the active chamber there is created a guidance of the linear fibre core, which comprises a guiding cylinder arranged outside the spinning space of the electric field, while through the spinning space of the electric field at least two straight segments of the linear fibre core are guided, between which the core is guided at least on a section of circumference of the guiding cylinder, and in projection into a plane being tangential to circumference of the guiding cylinder and passing the respective segment of the core, the core and longitudinal axis of the guiding cylinder contain an acute angle.

13. A device according to claim 12, wherein the guidance of the linear fibre core comprises two guiding cylinders arranged outside the spinning space of electric field on its opposite sides, while longitudinal axes of guiding cylinders are mutually intersecting, and the linear fibre core is guided on at least a section of circumference of both guiding cylinders, while in projection into a plane being tangential to circumference of the guiding cylinder and passing the respective segment of the core, the core and longitudinal axes of the guiding cylinders contain an acute angle.

14. A device according to the claim 12, wherein the guidance of the linear fibre core comprises two guiding cylinders arranged outside the spinning space of the electric field on its opposite sides, while longitudinal axes of guiding cylinders are mutually skew, and the linear fibre core is guided on at least a section of circumference of both guiding cylinders, while in projection into a plane being tangential to circumference of the guiding cylinder and passing the respective segment of the core, the core and longitudinal axes of the guiding cylinders contain an acute angle.

15. A device according to claim 12, wherein the electric field is induced between the spinning electrode and electrically conducting linear fibre core.

16. A device according to claim 15, wherein in front of the first entry of the linear fibre core into the spinning space of electric field there is arranged an applying unit for applying of electrically conducting liquid on the linear fibre core.

17. A device according to claim 16, wherein behind the last exit of the linear fibre core with nanofibres from the spinning space of electric field there is arranged a device for removing of at least part of electrically conducting liquid from the linear fibre core.

18. A device according to claim 12, wherein behind the last exit of the linear fibre core with nanofibres from the spinning space there is arranged a device for mechanical and/or heat fixation of nanofibres to the linear fibre core.

19. A device according to claim 12, wherein behind the last exit of the linear fibre core with nanofibres from the spinning space there is arranged a device for its coiling around with at least one covering thread.

20. A device according to claim 19, wherein behind the last exit of the linear fibre core with nanofibres from the spinning space there is arranged a device for its coiling around with at least two covering threads.
